(19) United States
(12) Patent Application Publication
(10) Pub. No.: US 2014/0149931 A1
(43) Pub. Date: May 29, 2014

(54) INFORMATION PROCESSING APPARATUS AND DISPLAY CONTROL METHOD

(71) Applicant: KABUSHIKI KAISHA TOSHIBA, Tokyo (JP)

(72) Inventor: Tsukasa Miki, Iruma-shi (JP)

(73) Assignee: KABUSHIKI KAISHA TOSHIBA, Tokyo (JP)

(21) Appl. No.: 13/971,683

(22) Filed: Aug. 20, 2013

(30) Foreign Application Priority Data
Nov. 29, 2012 (JP) 2012-261269

(51) Int. Cl. G06F 3/0481

(52) U.S. Cl. CPC G06F 3/0481
USPC 715/803

(57) ABSTRACT

According to one embodiment, an information processing apparatus includes a setting controller, a display processor, and a saving storage processor. The setting controller sets a plurality of areas on a desktop screen in accordance with a screen layout for the desktop screen comprising a plurality of regions. The display processor allocates an application window on the desktop screen to one of the plurality of areas to display the application window in the one of the plurality of areas. The saving storage processor automatically saves setting information when the application window is allocated to the one of the plurality of areas and is displayed in the one of the plurality of areas.

### CROSS-REFERENCE TO RELATED APPLICATIONS

This application is based upon and claims the benefit of priority from Japanese Patent Application No. 2012-261269, filed Nov. 29, 2012, the entire contents of which are incorporated herein by reference.

### FIELD

Embodiments described herein relate generally to an information processing apparatus capable of displaying a plurality of windows, and a display control method to be applied to the apparatus.

### BACKGROUND

Recently, various information processing apparatuses such as tablet computers and notebook personal computers (PCs) have been developed. Many information processing apparatuses of this kind can display windows (application windows) corresponding to a plurality of application programs on a screen.

An information processing apparatus of this kind can also store the display state of an application window displayed on the screen.

However, the user must perform a complicated operation in order to store the display state of an application window. For example, when the display position or the like of an application window is changed, the user must perform a complicated operation of, e.g., selecting a button for storing the display state of the application window.

In addition, as the resolution of displays increases and wide-screen displays spread in recent years, a technique of efficiently using a wide desktop screen is needed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an information processing apparatus according to an embodiment;

FIG. 2 is an exemplary block diagram showing the system configuration of the information processing apparatus of the embodiment;

FIG. 3 is an exemplary block diagram showing a configuration example of a split screen utility program executed by the information processing apparatus of the embodiment;

FIG. 4 is an exemplary diagram showing a split setting screen displayed by the split screen utility program shown in FIG. 3;

FIG. 5 is an exemplary view showing a state in which a window on the desktop screen of the information processing apparatus of the embodiment is not fitted;

FIG. 6 is an exemplary view showing a state in which a window on the desktop screen of the information processing apparatus of the embodiment is fitted;

FIG. 7 is an exemplary view showing a menu screen for selecting a profile or history, which is displayed by the split screen utility program shown in FIG. 3;

FIG. 8 is an exemplary view showing a state in which a window on the desktop screen of the information processing apparatus of the embodiment is refitted;

FIG. 9 is an exemplary view showing a state in which a window on the desktop screen is fitted in accordance with a history saved by the split screen utility program shown in FIG. 3;

FIG. 10 is an exemplary flowchart showing the procedure of a display control process executed by the split screen utility program shown in FIG. 3 when a fit button in a window is pressed;

FIG. 11 is an exemplary flowchart showing the procedure of a display control process executed by the split screen utility program shown in FIG. 3 in response to the switching of screen split settings; and

FIG. 12 is an exemplary view showing another example of the menu screen, which is displayed by the split screen utility program shown in FIG. 3, for selecting a profile or history.

### DETAILED DESCRIPTION

Various embodiments will be described hereinafter with reference to the accompanying drawings.

In general, according to one embodiment, an information processing apparatus includes a setting controller, a display processor, and a saving storage processor. The setting controller sets a plurality of areas on a desktop screen in accordance with a screen layout for the desktop screen comprising a plurality of regions. The display processor allocates an application window on the desktop screen to one of the plurality of areas to display the application window in the one of the plurality of areas. The saving storage processor automatically saves setting information when the application window is allocated to the one of the plurality of areas and is displayed in the one of the plurality of areas. The setting information is indicative of (i) identification information of an application program corresponding to the application window, (ii) the screen layout, and (iii) the area in which the application window is displayed.

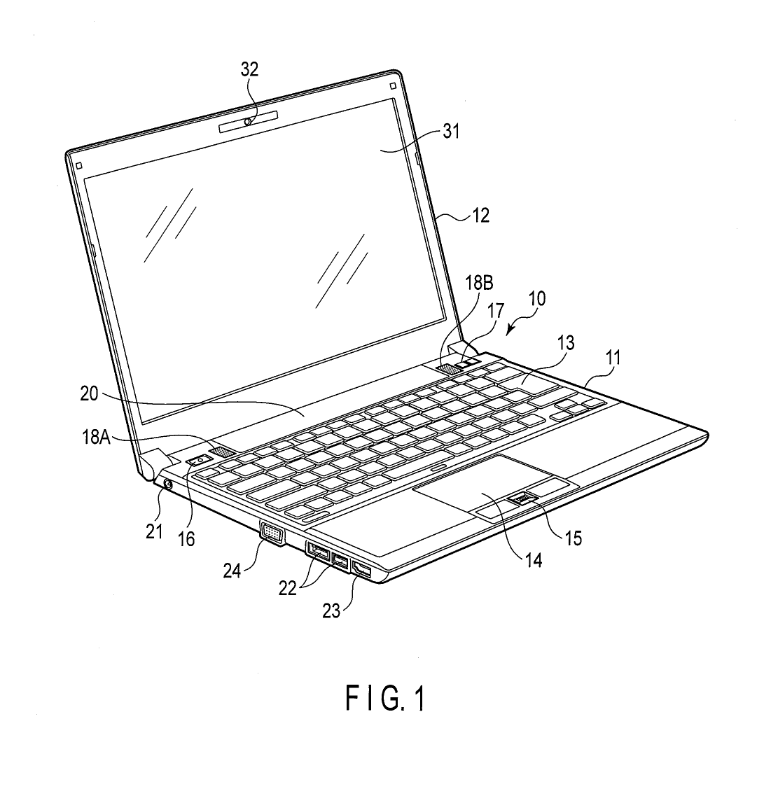

First, the configuration of the information processing apparatus according to this embodiment will be explained with reference to FIG. 1. This information processing apparatus can be implemented as a notebook type personal computer, a tablet terminal, or another information processing apparatus of any kind. In the following description, it is assumed that this information processing apparatus is implemented as a notebook type personal computer 10.

FIG. 1 is a perspective view showing, from the front, the computer 10 whose display unit 12 is open. The computer 10 is configured to receive electric power from a battery 20. The computer 10 includes a computer main body 11 and display unit 12. A display device such as a liquid crystal display (LCD) 31 is incorporated into the display unit 12. In addition, a camera (Web camera) 32 is arranged in the upper end portion of the display unit 12.

The display unit 12 is attached to the computer main body 11 rotatable between an open position where the upper surface of the computer main body 11 is exposed and a closed position where the upper surface of the computer main body 11 is covered with the display unit 12. The computer main body 11 has a thin boxy housing. A keyboard 13, a touchpad 14, a fingerprint sensor 15, a power switch 16 for powering on/off the computer 10, several function buttons 17, and loudspeakers 18A and 18B are arranged on the upper surface of the housing.

The computer main body 11 also includes a power connector 21. The power connector 21 is formed in a side surface, e.g., the left side surface of the computer main body 11. An external power supply is detachably connected to the power connector 21. An AC adaptor can be used as this external power supply. The AC adaptor is a power supply that converts commercial power (AC power) into DC power.

The battery 20 is detachably attached to, e.g., the rear end of the computer main body 11. The battery 20 may also be a built-in battery of the computer 10.

The computer 10 is driven by electric power from an external power supply or the battery 20. When an external power supply is connected to the power connector 21 of the computer 10, the computer 10 is driven by electric power from the external power supply. The electric power from the external power supply is also used to charge the battery 20. During a period in which the external power supply is not connected to the power connector 21 of the computer 10, the computer 10 is driven by the electric power from the battery 20.

In addition, the computer main body 11 includes several USB ports 22, an HDMI (High-Definition Multimedia Interface) output terminal 23, and an RGB port 24.

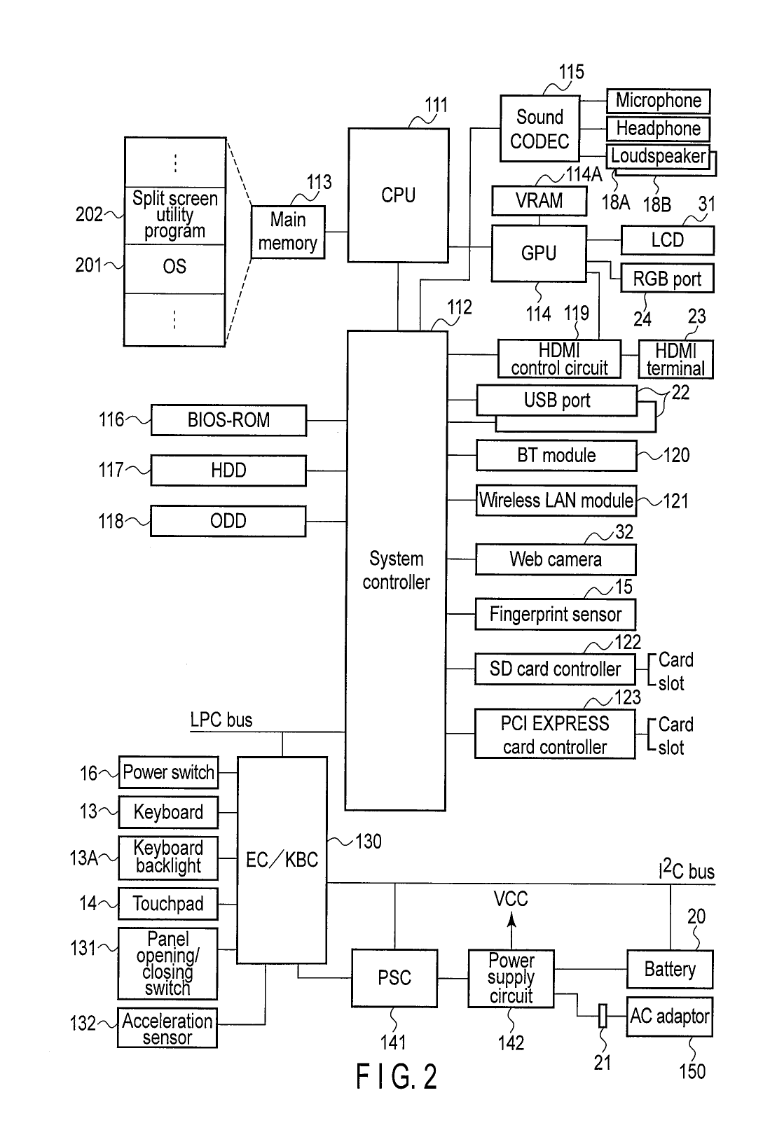

FIG. 2 shows the system configuration of the computer 10. The computer 10 includes a CPU 111, system controller 112, main memory 113, graphics processing unit (GPU) 114, sound codec 115, BIOS-ROM 116, hard disk driver (HDD) 117, optical disk drive (ODD) 118, BT (Bluetooth®) module 120, wireless LAN module 121, SD card controller 122, PCI EXPRESS card controller 123, embedded controller/keyboard controller IC (EC/KBC) 130, keyboard backlight 13A, panel opening/closing switch 131, acceleration sensor 132, power controller (PSC) 141, and power supply circuit 142.

The CPU 111 is a processor configured to control the operation of each component of the computer 10. The CPU 111 executes various kinds of software loaded into the main memory 113 from the HDD 117. The various kinds of software include an operating system (OS) 201 and various application/utility programs. The application/utility programs further include a split screen utility program 202. The split screen utility program 202 splits the desktop screen into a plurality of areas (split areas), and allocates an application window to one (a split area) of the plural areas to display the application window in the split area. For example, the split screen utility program 202 can fit an application window in a split area. Note that the split screen utility program 202 can also be set as a resident program.

The CPU 111 also executes a basic input/output system (BIOS) stored in the BIOS-ROM 116 as a nonvolatile memory. The BIOS is a system program for hardware control.

The GPU 114 is a display controller which controls the LCD 31 used as a display monitor of the computer 10. The GPU 114 generates a display signal (LVDS signal) to be supplied to the LCD 31, from display data stored in a video memory (VRAM) 114A. The GPU 114 can also generate an analog RGB signal and HDMI video signal from display data. The analog RGB signal is supplied to an external display via the RGB port 24. The HDMI output terminal 23 can supply the HDMI video signal (uncompressed digital video signal) and a digital audio signal to an external display by using one cable. An HDMI control circuit 119 is an interface for supplying the HDMI video signal and digital audio signal to an external display via the HDMI output terminal 23.

The system controller 112 is a bridge device for connecting between the CPU 111 and each component. The system controller 112 incorporates a serial ATA controller for controlling the hard disk drive (HDD) 117 and optical disk drive (ODD) 118. Furthermore, the system controller 112 communicates with each device on an LPC (Low PIN Count) bus.

The EC/KBC 130 is connected to the LPC bus. The EC/KBC 130, power supply controller (PSC) 141, and battery 20 are connected to each other via a serial bus such as an I2C bus.

The EC/KBC 130 is a power management controller for executing power management of the computer 10. For example, the EC/KBC 130 is implemented as a one-chip microcomputer incorporating a keyboard controller for controlling the keyboard (KB) 13 and touchpad 14. The EC/KBC 130 has a function of powering the computer 10 on/off in response to the operation of the power switch 16 by the user. The power on/off control of the computer 10 is executed by the cooperation of the EC/KBC 130 and power supply controller (PSC) 141. When receiving an ON signal transmitted from the EC/KBC 130, the power supply controller (PSC) 141 powers on the computer 10 by controlling the power supply circuit 142. When receiving an OFF signal transmitted from the EC/KBC 130, the power supply controller (PSC) 141 powers off the computer 10 by controlling the power supply circuit 142. The EC/KBC 130, power supply controller (PSC) 141, and power supply circuit 142 operate by electric power from the battery 20 or AC adaptor 150 even during a period in which the computer 10 is OFF.

In addition, the EC/KBC 130 can turn on/off the keyboard backlight 13A arranged behind the keyboard 13. Furthermore, the EC/KBC 130 is connected to the panel opening/closing switch 131 configured to detect the opening/closing of the display unit 12. When the panel opening/closing switch 131 detects the opening of the display unit 12, the EC/KBC 130 can power on the computer 10.

The power supply circuit 142 generates electric power (operating power) to be supplied to each component by using electric power from the battery 20, or by using electric power from the AC adaptor 150 connected as an external power supply to the computer main body 11.

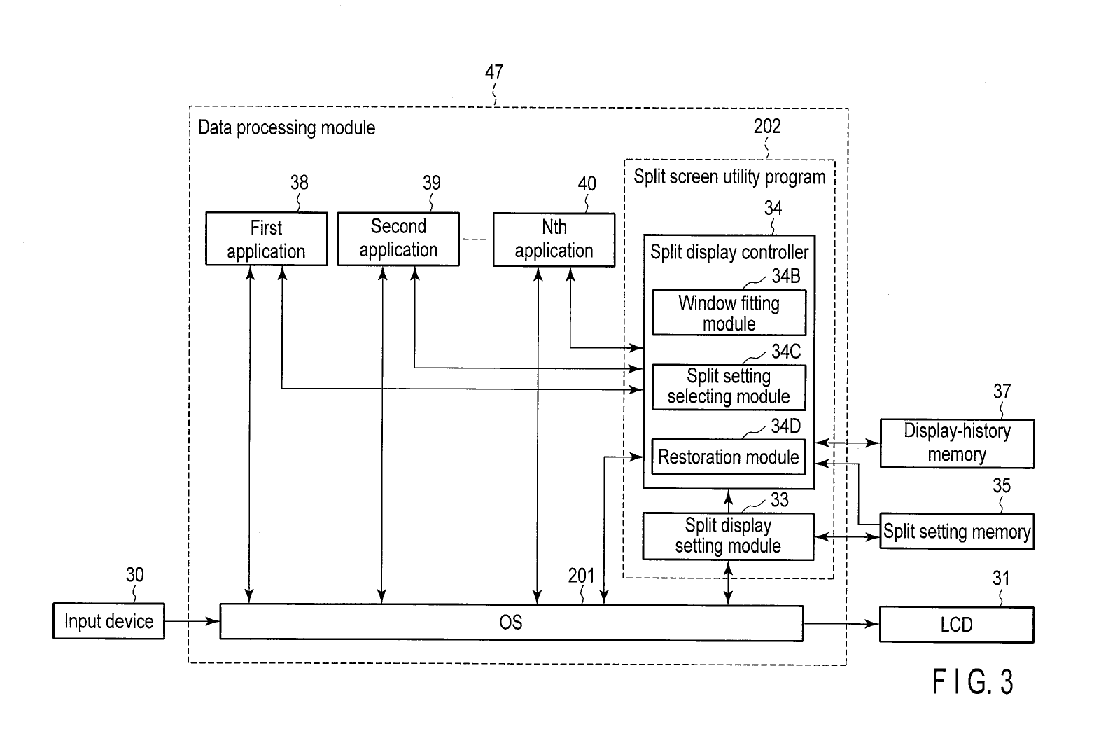

Next, the configuration of the split screen utility program 202 operating on the computer 10 having the configuration as described above will be explained with reference to FIG. 3.

The split screen utility program 202 is a user assisting program for readily setting an application window in a desired display state. An application window is a window corresponding to an application program. The application window can be displayed on the desktop screen. A content referred to by the application program is displayed in the application window corresponding to the application program.

Details will be explained below with reference to FIG. 3. A data processing module 47 of the computer 10 includes the OS 201, the split screen utility program 202, and first application 38 to nth application 40.

The OS 201 causes the LCD 31 to display the desktop screen and an application window on the desktop screen, in accordance with an instruction from an input device 30. The input device 30 is, e.g., a mouse or the keyboard 13. Instead of displaying the desktop screen and the application window on the LCD 31, it is also possible to display the desktop screen and the application window on the screen of an external display.

Each of first application 38 to nth application 40 is an application program capable of displaying a content in an application window on the desktop screen.

The split screen utility program 202 includes a split display setting module 33 and split display controller 34.

The split display setting module 33 sets a plurality of areas on the desktop screen in accordance with a screen layout (profile) for splitting the desktop screen into a plurality of regions. That is, the split display setting module 33 sets a plurality of areas on the desktop screen in accordance with a screen layout (profile) for the desktop screen having a plurality of regions. The desktop screen is split into a plurality of regions by the screen layout (profile). The profile is previously formed as a default or formed by user's customization. The split display setting module (setting controller) 33 can set a plurality of areas (split areas) on the desktop screen in accordance with a profile selected by the user from a plurality of profiles. Each of the profiles includes one or more boundaries for dividing (splitting) the desktop screen into a plurality of regions. The profiles differ from each other in the positions of the more boundaries or the numbers of the boundaries. Each of the plural profiles indicates arrangement positions on the desktop screen, which correspond to the above-described plural split areas. A split setting memory 35 stores the plural profiles described above.

The split display control module 34 executes a process of arranging application windows in the split areas set by the split display setting module 33. The split display control module 34 includes a window fitting module 34B, split setting selecting module 34C, and restoration module 34D.

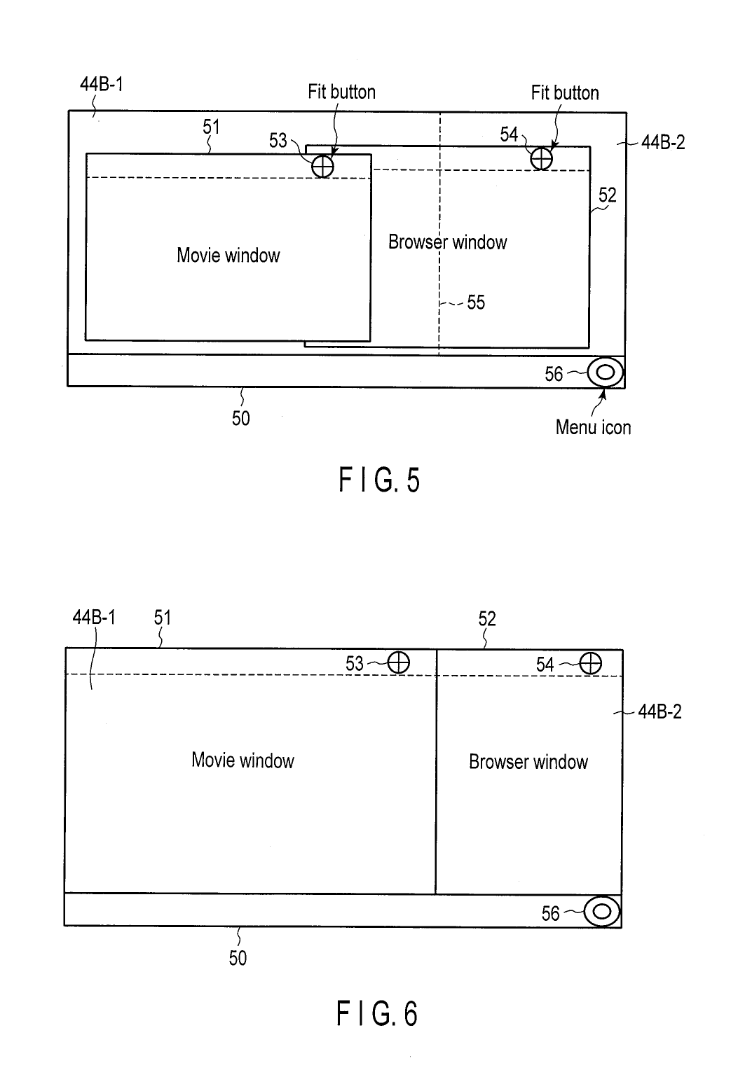

The window fitting module 34B allocates an application window to one of a plurality of split areas to display the application window in the one of the plural split areas. That is, the window fitting module 34B fits the application window in the one of the plural split areas. Also, when the user operates a certain graphical user interface in an application window, the window fitting module 34B selects a split area to which the graphical user interface belongs, from the plural split areas. The window fitting module 34B can also fit the application window in the selected split area. The graphical user interface is, e.g., a Fit button to be described later with reference to FIG. 5.

Furthermore, in accordance with the position and size of a split area in which an application window is to be displayed by allocating the window to the area, the window fitting module 34B changes the position and size of the application window, and fits the application window in the split area.

When the window fitting module 34B fits an application window in each of a plurality of split areas, the split display controller 34 automatically saves setting information (split setting information) as the history of the used split setting in a display-history memory 37. The split setting information indicates the present split setting (a profile presently being used), and identification information (an identifier) of an application program corresponding to an application window fitted in each split area. More specifically, when application windows are fitted in all split areas, the split display controller 34 automatically saves, in the display-history memory 37, split setting information indicating the identifiers of application programs corresponding to these application windows, the present split setting (a profile presently being used), and the split areas in which the application windows are fitted.

Note that the above-described saving process need not be performed under the condition that application windows are fitted in all split areas. For example, the saving process may also be performed under the condition that an application window is fitted in one predetermined split area. In this case, when an application window is fitted in one predetermined split area, the split display controller 34 automatically saves split setting information, as the history of split setting, in the display-history memory 37. The split setting information indicates the identifier of an application program corresponding to the application window, the present split setting (a profile presently being used), and the one predetermined split area in which the application window is fitted. In this embodiment as described above, when at least one application window is fitted in a split area, the present fitting state is automatically saved. Note that the identifier of an application program is, for example, the process ID (PID) of the application program.

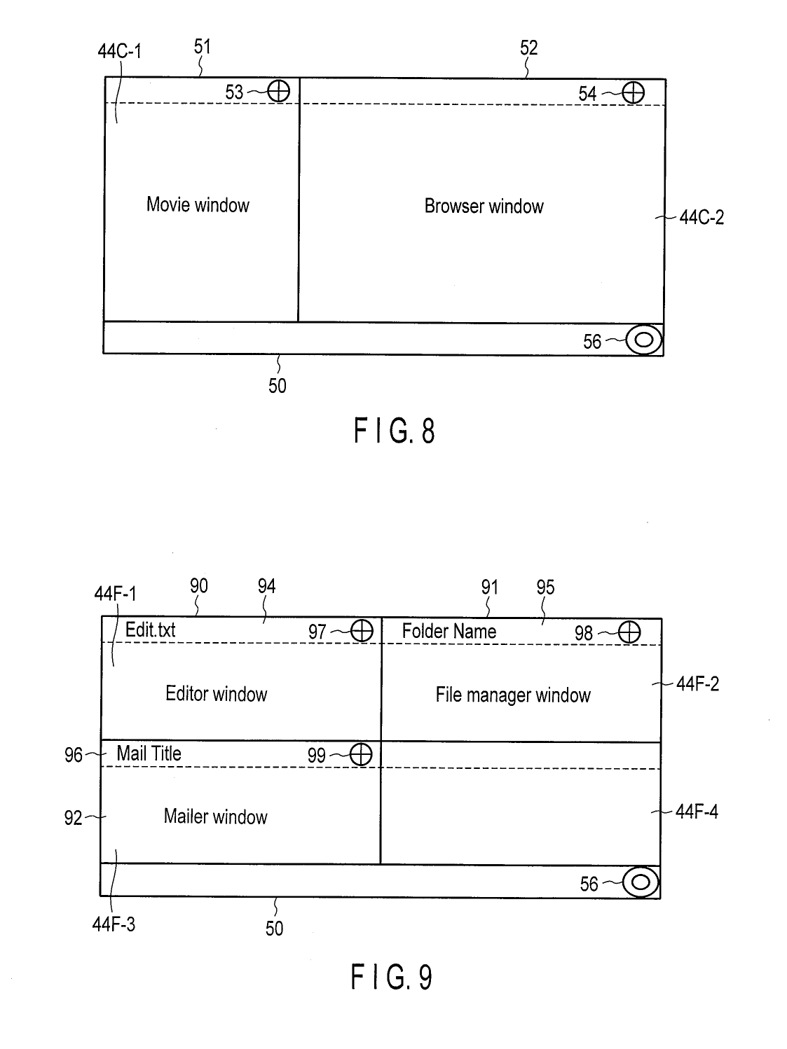

The split setting selecting module 34C switches the split setting (profile) presently being applied to another split setting (another profile), and refits application programs in a plurality of split areas which are newly set on the desktop screen in accordance with the selected profile. Note that refitting will be described later with reference to FIG. 8.

The split setting information to be saved in the display-history memory 37 can further contain an identifier indicating a content being referred to by an application program fitted in a split area.

Thus, the split screen utility program 202 has the function of automatically saving, as a history (display history), the split setting information indicating the present split setting (a profile presently being used) and the identifier of an application program corresponding to an application window fitted in each split area. Accordingly, the display state of the desktop screen can readily be restored to a display state set by the split screen utility program 202 in the past by using a saved arbitrary history, i.e., by using a saved arbitrary split setting information. The restoration module 34D executes this restoration process.

That is, in accordance with split setting information selected by the user from a plurality of pieces of split setting information stored in the display-history memory 37, the restoration module 34D restores the state of the desktop screen to a display state defined by the selected split setting information.

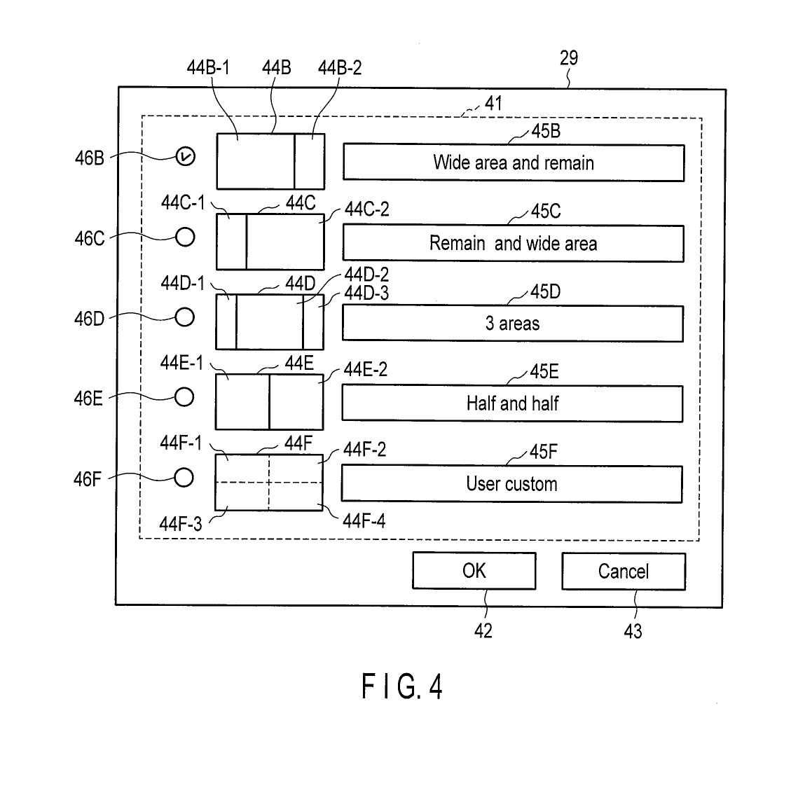

FIG. 4 shows a split setting screen to be displayed on the desktop screen by the split setting memory 35.

A split setting screen 29 is a dialogue for allowing the user to select a profile to be used from a plurality of profiles described above, and is displayed on the desktop screen in accordance with a predetermined setting operation by the user.

The split setting screen 29 includes a profile display area 41, OK button 42, and cancel button 43. The profile display area 41 displays a plurality of preset profiles (default profiles), and a profile (customized profile) customized by the user. The plurality of default profiles and customized profile are stored in the split setting memory 35. The user can select an arbitrary default profile or customized profile. As shown in FIG. 4, the plurality of default profiles include, e.g., a “Wide area and remain” profile, “Remain and wide area” profile, “3 areas” profile, and “Half and half” profile. The customized profile is, e.g., a “User custom” profile as shown in FIG. 4. Check boxes 46B, 46C, 46D, 46E, and 46F, layout thumbnails 44B, 44C, 44D, 44E, and 44F, and profile names 45B, 45C, 45D, 45E, and 45F is displayed the profile display area 41. The user can select a profile corresponding to one of the check boxes 46B, 46C, 46D, 46E, and 46F by clicking the check box. When the check box 46B is clicked, a check mark is displayed in the check box 46.

As indicated by the layout thumbnail 44B, the “Wide area and remain” profile is a profile for splitting the desktop screen into two areas, i.e., areas 44B-1 and 44B-2. The area 44B-1 is larger than the area 44B-2. Also, the area 44B-1 has an aspect ratio of, e.g., 16:9, and is wider than the area 44B-2.

As indicated by the layout thumbnail 44C, the “Remain and wide area” profile is a profile for splitting the desktop screen into two areas, i.e., areas 44C-1 and 44C-2. The area 44C-2 is larger than the area 44B-1. Also, the area 44C-2 has an aspect ratio of, e.g., 16:9, and is wider than the area 44C-1.

As indicated by the layout thumbnail 44D, the “3 areas” profile is a profile for splitting the desktop screen into three areas, i.e., areas 44D-1, 44D-2, and 44D-3. The central area 44D-2 is larger than the left area 44D-1 and right area 44D-3. Also, the area 44D-2 has an aspect ratio of, e.g., 16:9, and is wider than the areas 44D-1 and 44D-3.

As indicated by the layout thumbnail 44E, the “Half and half” profile is a profile for splitting the desktop screen into two areas, i.e., areas 44E-1 and 44E-2. The areas 44E-1 and 44E-2 have the same size.

As indicated by the layout thumbnail 44F, the “User custom” profile is a profile for splitting the desktop screen into four areas, i.e., areas 44F-1, 44F-2, 44F-3, and 44F-4. Note that the “User custom” profile need not be the profile for splitting the desktop screen into four areas as indicated by the layout thumbnail 44F. For example, the “User custom” profile may also be a profile for splitting the desktop screen into n areas by the user. As an example, the user can split the desktop screen into k areas in the vertical direction and m areas in the horizontal direction. Note that each of n, k, and m is an integer of 2 or more.

Next, an example of a state in which an application window is not fitted in any split area will be explained with reference to FIG. 5.

FIG. 5 shows a state in which an application window is not fitted while the “Wide area and remain” profile is selected. The desktop screen 50 is split into the areas 44B-1 and 44B-2 by a boundary line 55. Also, the desktop screen 50 includes a region for displaying a menu icon 56 and the like as shown in FIG. 5. On the desktop screen 50, two application windows are displayed at a state that two application windows are not fitted. As shown in FIG. 5, the two application windows are a “Movie window” 51 and “Browser window” 52. The “Movie window” 51 is a window corresponding to an application program for playing back a movie. Images corresponding to the movie are displayed as a content in the “Movie window” 51. The “Browser window” 52 is a window corresponding to a browser application program such as a web browser. For example, a web page designated by a URL is displayed as a content in the “Browser window” 52.

The “Movie window” 51 has a Fit button 53. The “Browser window” 52 has a Fit button 54. The Fit button 53 is a graphical user interface (GUI) for fitting the “Movie window” 51 in the area 44B-1 or 44B-2. The Fit button 54 is a graphical user interface for fitting the “Browser window” 52 in the area 44B-1 or 44B-2. When the user operates the Fit button 53, the split screen utility program 202 selects the area 44B-1 to which the Fit button 53 belongs, from the areas 44B-1 and 44B-2, and fits the “Movie window” 51 in the area 44B-1. Likewise, when the user operates the Fit button 54, the split screen utility program 202 selects the area 44B-2 to which the Fit button 54 belongs, from the areas 44B-1 and 44B-2, and fits the “Browser window” 52 in the area 44B-2.

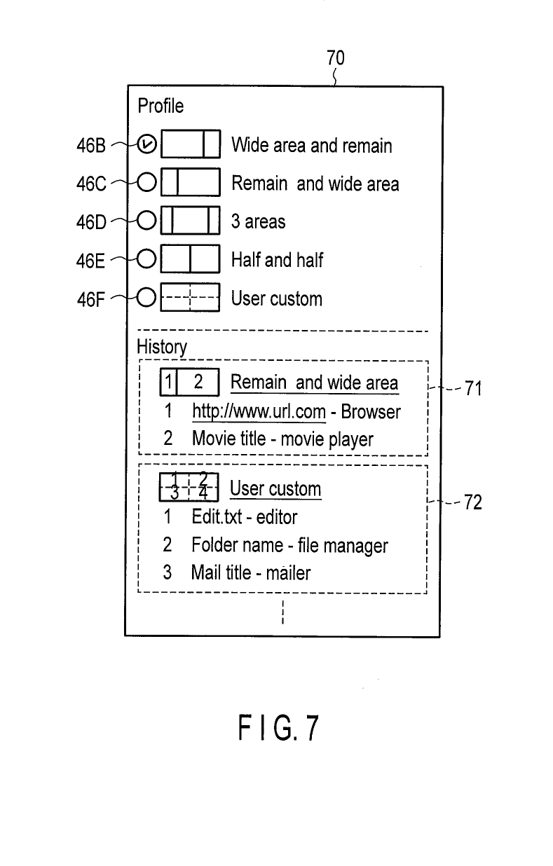

Note that the user's operation on the Fit button 53 or 54 is, for example, an operation of clicking the Fit button 53 or 54 by using a mouse or the like. Note also that the menu icon is a graphical user interface for displaying a selection screen for selecting a profile or history as will be described later with reference to FIG. 7.

An example of a state in which application windows are fitted on the desktop screen will be explained below with reference to FIG. 6.

FIG. 6 shows a state in which the “Movie window” 51 and “Browser window” 52 are fitted in their respective areas when the user operates the Fit buttons 53 and 54 from the state in which an application window is not fitted while the “Wide area and remain” profile is selected as shown in FIG. 5.

The “fitted state” herein mentioned is a state in which an application window having a size equivalent to the size of one area is displayed in the position of the area on the desktop screen. A size equivalent to the size of one area is, e.g., the same size as that of one area. More specifically, as shown in FIG. 6, the “Movie window” 51 having the same size as that of the area 44B-1 is displayed in the position of the area 44B-1 on the desktop screen 50. Similarly, the “Browser window” 52 having the same size as that of the area 44B-2 is displayed in the position of the area 44B-2 on the desktop screen 50.

An example of a menu screen 70 for selecting a profile or history will now be explained with reference to FIG. 7.

The menu screen 70 shown in FIG. 7 is displayed when the user clicks the menu icon 56 as shown in FIGS. 5 and 6. The menu screen 70 is also displayed when the Fit button is right-clicked. The menu screen 70 displays the plurality of profiles, and the history as above described. On the menu screen 70, a check mark is displayed in a check box corresponding to a profile presently being selected. Referring to FIG. 7, a check mark is displayed in the check box 46B.

The history area of the menu screen 70 displays the contents of all pieces of split setting information stored in the display-history memory 37, as the history of split settings used in the past. That is, the history area of the menu screen 70 displays a list of histories. Referring to FIG. 7, the history area displays splitting settings 71 and 72. The split setting 71 shows the contents of certain split setting information stored in the display-history memory 37. For example, the split setting 71 shows that the “Remain and wide area” profile is selected, an application window corresponding to Browser is displayed in the area 44C-1, and an application window corresponding to Movie Player is displayed in the area 44C-2. In addition, the URL of a content referred to by Browser and the name of Browser are displayed like “http://www.url.com—Browser” as application program information of Browser. Likewise, the title of a video content (movie) referred to by Movie Player and the name of Movie Player are displayed like “Movie Title—Movie Player” as application information of Movie Player.

The split setting 72 shows the contents of another split setting information stored in the display-history memory 37. For example, the split setting 72 shows that the “User custom” profile is selected, an application window corresponding to Editor is displayed in the area 44F-1, an application window corresponding to File Manager is displayed in the area 44F-2, and an application window corresponding to Mailer is displayed in the area 44F-3. In addition, the file name of the content of a text file referred to by Editor and the name of Editor are displayed like “Edit.txt—Editor” as application program information of Editor. Similarly, the content name of a data folder referred to by File Manager and the name of File Manager are displayed like “Folder Name—File Manager” as application information of File Manager. Analogously, the content name of mail data referred to by Mailer and the name of Mailer are displayed like “Mail Title—Mailer” as application information of Mailer.

Note that the list of histories, i.e., the list of split settings used in the past can be displayed by arranging the split settings in time series in the order by which the pieces of split setting information are stored in the display-history memory 37. Note that the list of histories can be displayed by arranging the splitting settings such that a history (split setting information) restored the largest number of times by the restoration module 34D is displayed at higher position. Also, in the split settings 71, 72, the area numbers “1”, “2”, and “3” indicate the split areas. In the split setting 71, the area 44C-1 is displayed as area number “1”, and the area 44C-2 is displayed as area number “2”, thereby making each area correspond to the number displayed on the left side of each of application program information. Note that it is unnecessary to display area numbers “1” and “2” and the like.

An example of a window display state when profiles are switched will be explained below with reference to FIG. 8.

FIG. 8 assumes that the menu screen 70 of FIG. 7 is displayed on the desktop screen 50 of FIG. 6 on which the “Wide area and remain” profile is selected, and the profile is switched from the “Wide area and remain” profile to the “Remain and wide area” profile.

Each application window is refit as shown in FIG. 8. “Refit” is a process by which each application window, which is fitted before a profile is switched to another profile, is fitted in a predetermined area of said another profile again, thereby changing the layout of application windows. A predetermined area is determined based on position information of each application program. The position information of each application program is, e.g., coordinate information of the application program in the coordinate system of the desktop screen. The coordinate information of each application window may be coordinate information of the Fit button of the application window. The coordinate information of each application window may also be coordinate information of a predetermined position of the application window, e.g., the position of the upper left corner of the application window when the application window is a square. More specifically, as shown in FIG. 8, when the “Wide area and remain” profile is switched to the “Remain and wide area” profile, the area 44C-1 is a predetermined area of the “Movie window” 51, so the “Movie window” 51 is refitted in the area 44C-1 from the area 44B-1. That is, the display state of the “Movie window” 51 transits from the state in which the “Movie window” 51 is fitted in the area 44B-1 to the state in which the “Movie window” 51 is fitted in the area 44C-1. Similarly, when the “Wide area and remain” profile is switched to the “Remain and wide area” profile, the area 44C-2 is a predetermined area of the “Browser window” 52, so the “Browser window” 52 is refitted in the area 44C-2 from the area 44B-2. That is, the display state of the “Browser window” 52 transits from the state in which the “Browser window” 52 is fitted in the area 44B-2 to the state in which the “Browser window” 52 is fitted in the area 44C-2.

An example of a display state of an application window when the history 72 is selected on the menu screen 70 will be explained below with reference to FIG. 9.

FIG. 9 assumes a state in which the menu screen 70 as shown in FIG. 7 is displayed in the display state of the desktop screen 50 on which the “Wide area and remain” profile is selected as described above with reference to FIG. 6, and the history 72 is selected. And then FIG. 9 assumes the state of the desktop screen 50 is switched (restored), in accordance with the split setting information of the history 72, to the state in which a plurality of areas are set on the desktop screen 50 and each application window is fitted in one of the plurality of areas.

The split setting information of the history 72 contains information concerning customized profile for splitting the desktop screen into four areas (four regions), information concerning each area, and information concerning three application programs associated with three areas. An “Editor window” 90 corresponding to Editor is displayed as it is fitted in the area 44F-1 associated with Editor. Similarly, a “File Manager window” 91 corresponding to File Manager is displayed as it is fitted in the area 44F-2 associated with File Manager. A “Mailer window” 92 corresponding to Mailer is displayed as it is fitted in the area 44F-3 associated with Mailer. Note that an application window do not needs to be displayed in the area 44F-4. The “Editor window” 90 displays an area 94 for displaying the file name of the content of a text file referred to by Editor and a Fit button 97. Likewise, the “File Manager window” 91 displays an area 95 for displaying the content name of a data folder referred to by File Manager and a Fit button 98. The “Mailer window” 92 displays an area 96 for displaying the content name of mail data referred to by Mailer and a Fit button 99. Note that the area 94, 95, or 96 need not be displayed.

As explained above with reference to FIG. 8, when profiles are switched, the split screen utility program 202 performs the process of refitting an application window fitted before the profiles are switched. And as explained above with reference to FIG. 9, when a history on the menu screen 70 is selected, the split screen utility program 202 changes (restores) the display state of an application window in accordance with the split setting information of the selected history.

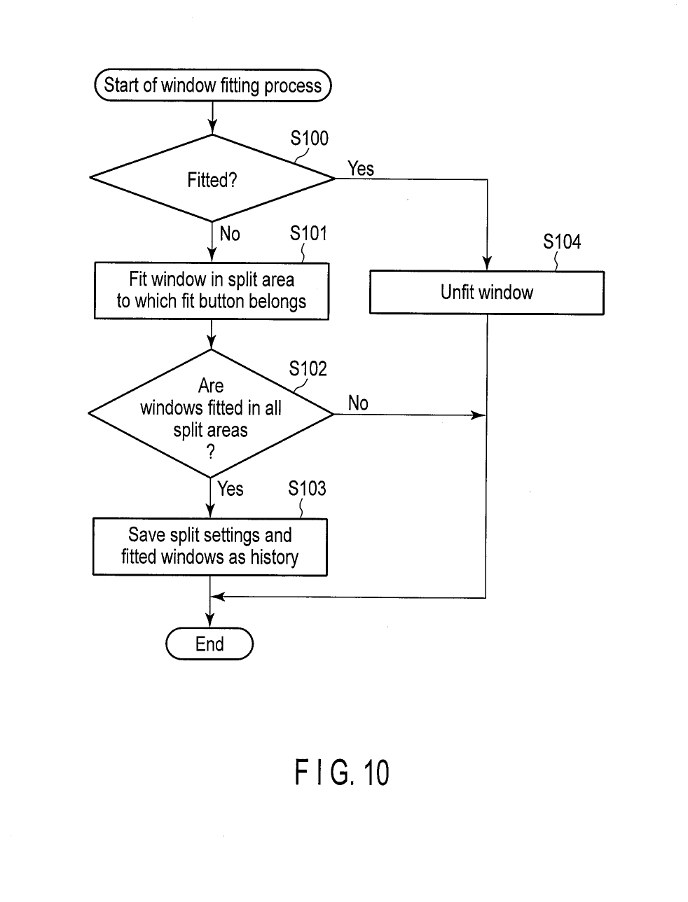

Next, the procedure of the application window fitting process executed by the split screen utility program 202 will be explained with reference to FIG. 10.

When the Fit button of an application window on the desktop screen 50 is clicked, the split screen utility program 202 determines whether this application window is fitted in a split area (step S100). If the application window is fitted in the split area (YES in step S100), the split screen utility program 202 unfits the window (step S104). “Unfit” is a process for changing the display state of an application window such that the application window is not fitted in any split area. For example, an application window having a size before the window is fitted in a split area can be displayed in a position before the window is fitted in the split area. If the application window is not fitted (NO in step S100), the split screen utility program 202 fits the application window in a split area to which the fit button of the application window belongs (step S101). Then, the split screen utility program 202 determines whether application windows are fitted in all split areas (step S102). If there is a split area in which an application window is not fitted (NO in step S102), the split screen utility program 202 terminates the application window fitting process. If application windows are fitted in all split areas (YES in step S102), the split screen utility program 202 automatically stores (saves) an application program corresponding to each fitted application window as split setting information, in association with a profile presently being used and a split area in which the application window is fitted (step S103).

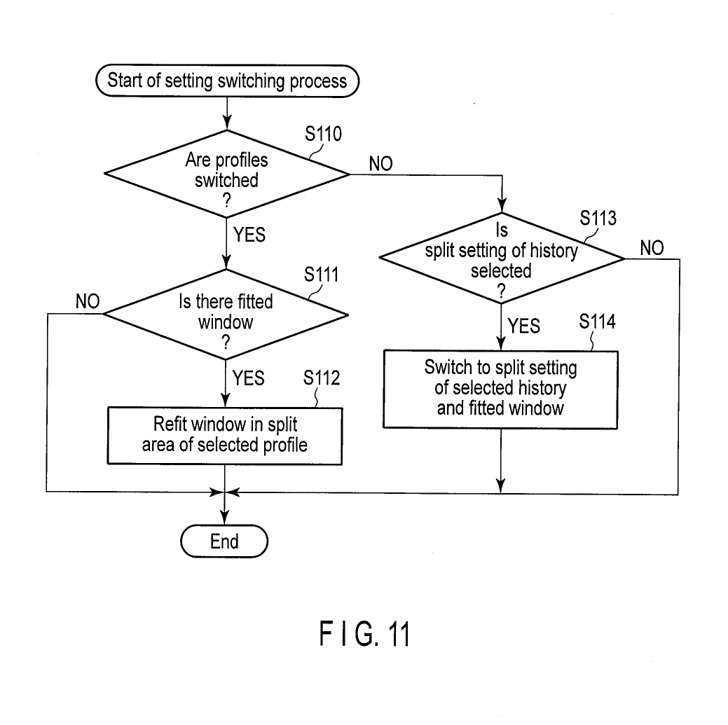

The procedure of the profile (setting) switching process executed by the split screen utility program 202 will be explained below with reference to FIG. 11.

The profile switching process is started by, e.g., displaying the menu screen 70. The split screen utility program 202 determines whether profiles are switched (step S110). If profiles are switched (YES in step S110), the split screen utility program 202 determines whether there is an application window fitted in a split area corresponding to a profile before the switching (step S111). If there is not application window fitted in the split area corresponding to the profile before the switching (NO in step S111), the split screen utility program 202 does not perform process for refitting. If there is an application window fitted in the split area corresponding to the profile before the switching (YES in step S111), the split screen utility program 202 refits the application window in a split area corresponding to a profile selected (switched) on the menu screen 70 (step S112).

On the other hand, if switching profile is not performed in step S110 (NO in step S110), the split screen utility program 202 determines whether a predetermined history (split setting) on the menu screen 70 is selected (step S113). If a history is not selected (NO in step S113), the profile switching process is terminated by, e.g., stopping displaying the menu screen 70. If a history is selected (YES in step S113), the split screen utility program 202 switches a split setting to be used (a profile to be used) to a split setting (profile) indicated by split setting information corresponding to the selected history, in accordance with the split setting information of the selected history. And the split screen utility program 202 fits an application window of each application indicated by the split setting information in a split area corresponding to the selected profile, in accordance with the split setting information of the selected history (step S114). For example, if the split setting 71 shown in FIG. 7 is selected, the split screen utility program 202 sets the two split areas on the desktop screen again, fits the window of Browser in the left split area, and fits Movie Player in the right split area. Thus, the split screen utility program 202 restores the state of the desktop screen to the state indicated by the split setting 71. The split setting 71 contains identification information (an identifier) indicating a content referred to by each application program. Accordingly, contents referred to in the past are also displayed in the Browser window and Movie Player. If Browser has not been launched yet, the split screen utility program 202 may launch Browser. Likewise, if Movie Player has not been launched, the split screen utility program 202 may launch Movie Player.

Note that each application window displayed on the desktop screen before the history is selected can also be minimized.

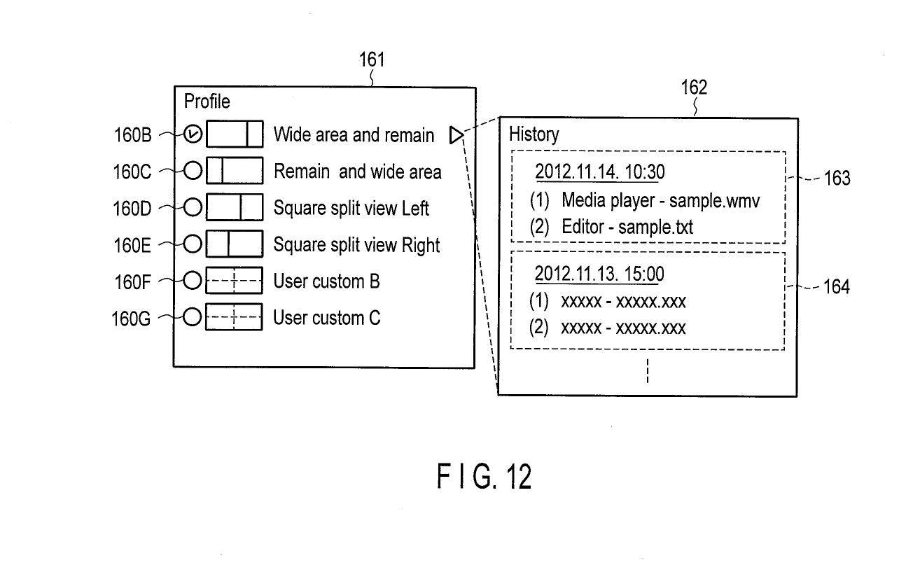

Next, an example of the display screen of the history list will be explained with reference to FIG. 12.

FIG. 12 shows a state in which histories are displayed on a submenu screen 162 of a profile, unlike the menu screen 70 described previously with reference to FIG. 7.

A menu screen shown in FIG. 12 includes a profile screen 161 for selecting a profile, and the submenu screen 162 for selecting a history.

Six profiles can be selected on the profile screen 161. A check box 160B is a check box for selecting the “Wide area and remain” profile. A check box 160C is a check box for selecting the “Remain and wide area” profile. A check box 160D is a check box for selecting a “Square split view left” profile. The “Square split view left” profile is a profile including a square area on the left side of the desktop screen 50. A check box 160E is a check box for selecting a “Square split view right” profile. The “Square split view right” profile is a profile including a square area on the right side of the desktop screen 50. A check box 160F is a check box for selecting a “User custom” profile B. A check box 160G is a check box for selecting a “User custom” profile C.

When the “Wide area and remain” profile is selected, a check mark is displayed in the check box 160B as shown in FIG. 12. When the “Wide area and remain” profile is selected, the submenu screen 162 is displayed. The submenu screen 162 displays a list of histories of the “Wide area and remain” profile. As shown in FIG. 12, the submenu screen 162 displays histories 163 and 164. The history 163 displays the date/time on which the display-history memory 37 stored split setting information (first split setting information) of the history 163. And the history 163 displays content information of an application program corresponding to an application window fitted on the date/time on which the first split setting information was stored. Similarly, the history 164 displays the date/time on which the display-history memory 37 stored split setting information (second split setting information) of the history 164. And the history 164 displays content information of an application program corresponding to an application window fitted on the date/time on which the second split setting information was stored. Note that as shown in FIG. 12, numbers “(1)” and “(2)” displayed on the left sides of the pieces of content information of the histories 163 and 164 respectively correspond to the areas 44B-1 and 44B-2 of the “Wide area and remain” profile.

As shown in FIG. 12, the histories 163 and 164 are displayed as the histories 163 and 164 are arranged in the order of the dates/times on which the first split setting information corresponding to the history 163 and the second split setting information corresponding to the history 164 were stored. Note that a history corresponding to split setting information having the latest storage date/time can be displayed either at higher position or at lower position.

In this embodiment as explained above, a plurality of areas can be set on the desktop screen 50 in accordance with a screen layout (profile) for splitting the desktop screen 50 into a plurality of regions. Also, an application window on the desktop screen 50 can be allocated to one of the plurality of areas and can be displayed in the one of the plurality of areas. That is, the application window can be fitted in the one of the plural areas. Furthermore, when an application window is displayed in one of the plurality of areas, identification information (an identifier) of an application program corresponding to the application window can automatically be stored as first setting information in association with the screen layout and the area in which the application window is displayed. This makes it possible to automatically store (save) the profile setting information and the display state of the application window. Accordingly, the user need not perform any special operation of storing the display state of the application window. It is also possible to switch profiles (select a profile) and switch application windows at the same time. This can improve the convenience. In addition, when application windows are switched, the application windows are automatically laid out and fitted. This makes the operation of laying out application windows faster and easier. More specifically, a state in which an application window is fitted can automatically be stored for each profile. Therefore, when a plurality of application windows are displayed, for example, the user need not perform any of an operation of grouping the plurality of application windows, an operation of moving the position of an application window and adjusting the size of the window, and an operation of deleting an application window.

Note that the split setting memory 35 may be store a single profile. In this case, the split setting memory 35 need not be associated the profile with split setting information. The restoration module 34D restores the state of the desktop screen to the state in which an application window is fitted in one of a plurality of areas of the single profile, in accordance with split setting information unassociated with the profile.

Also, when the Fit button is pressed by, e.g., clicking by the mouse, the split display controller 34 automatically stores split setting information in the display-history memory 37. However, even when the Fit button is not pressed, split setting information can be stored as a history if there is a fitted application window. Note that split setting information is stored when an application window is fitted in at least one area of a selected profile.

Furthermore, the split screen utility program 202 can minimize each application window displayed on the desktop screen before a history is selected as described above. Unlike minimizing each displayed application window, however, the state of the application window can also be maintained in the background of an application window corresponding to the identifier of an application program stored as a selected history. For example, the state of each application window displayed on the desktop screen before a history is selected may be maintained in the background without changing the position and size of the application window on the desktop screen.

For an identifier indicating a content to be stored in the split setting memory 37, an identifier indicating a content of an application program such as an application program formed by the user can also be preset so as not to be stored in association with the identifier of the application program. The application program formed by the user is other than those which are, for example, preinstalled in the computer 10,

Also, the shape of the areas 44B-1, 44B-2, . . . is a rectangle corresponding to the shape of an application window, but can also be, e.g., a circle if the shape of an application window is a circle.

In addition, when a plurality of Fit buttons such as the Fit buttons 53 and 54 are displayed on the desktop screen 50, a plurality of application windows displayed on the desktop screen 50 can be fitted, by pressing one of the plurality of Fit buttons, in areas to which these Fit buttons belong.

Furthermore, when the display history memory 37 stores a history for each of a plurality of profiles, it is also possible to store only a history having the latest date/time for each profile. In this case, the state of the desktop screen can be restored in accordance with split setting information corresponding to the history having the latest date/time by only switching profiles, without selecting a history such as that displayed on the submenu screen 162.

All the procedures explained in this embodiment can be executed by software. Therefore, the same effects as those of this embodiment can easily be implemented by only installing a program for executing the procedures in an ordinary computer by using a computer-readable, non-transitory storage medium storing the program, and executing the installed program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a setting controller configured to set a plurality of areas on a desktop screen in accordance with a screen layout for the desktop screen comprising a plurality of regions;
a display processor configured to allocate an application window on the desktop screen to one of the plurality of areas to display the application window in the one of the plurality of areas; and
a saving storage processor configured to automatically save setting information when the application window is allocated to the one of the plurality of areas and is displayed in the one of the plurality of areas,
wherein the setting information is indicative of (i) identification information of an application program corresponding to the application window, (ii) the screen layout, and (iii) the area in which the application window is displayed.

2. The apparatus of claim 1, further comprising a restorer configured to restore, in accordance with the setting information, a state of the desktop screen to a first state in which the plurality of areas are set on the desktop screen, and the application window is allocated to the one of the plurality of areas and is displayed in the one of the plurality of areas.

3. The apparatus of claim 1,
wherein the saving storage is further configured to save content identification information in association with the identification information of the application program, and
wherein the content identification information is indicative of a content referred to by the application program.

4. The apparatus of claim 1, wherein the setting controller is further configured to set a plurality of areas on the desktop screen in accordance with a first screen layout selected by a user from a plurality of screen layouts which differ from each other in positions of one or more boundaries or the number of the boundaries, the boundaries in the desktop screen comprising a plurality of regions.

5. The apparatus of claim 1,
wherein the display processor is further configured to:
when a user operates a first graphical user interface on the application window,
select, from the plurality of areas, a first area to which the first graphical user interface belongs; and
allocate the application window to the first area to display the application window in the first area.

6. The apparatus of claim 1, wherein the display processor is further configured to change a position and size of the application window in accordance with a position and size of the one of the plurality of areas to display the application window in the one of the plurality of areas.

7. The apparatus of claim 1,
wherein the setting controller is further configured to set a plurality of areas on the desktop screen in accordance with one of a plurality of screen layouts which differ from each other in positions of one or more boundaries or the number of the boundaries, the boundaries in the desktop screen comprising a plurality of regions,
wherein the saving storage is further configured to save automatically additionally setting information, when an application window is allocated to one of the plurality of areas and is displayed in the one of the plurality of areas, and
wherein the setting information is indicative of (i) identification information of an application program corresponding to the application window, (ii) the one of a plurality of screen layouts, and (iii) the area in which the application window is displayed.

8. The apparatus of claim 7, further comprising a history display processor configured to display a list of the saved setting information on the desktop screen.

9. A display control method comprising:
setting a plurality of areas on a desktop screen in accordance with a screen layout for the desktop screen comprising a plurality of regions;
allocating an application window on the desktop screen to one of the plurality of areas to display the application window in the one of the plurality of area; and
automatically saving setting information when the application window is allocated to the one of the plurality of areas and is displayed on the one of the plurality of areas,
wherein the setting information is indicative of (i) identification information of an application program corresponding to the application window, (ii) the screen layout, and (iii) the area in which the application window is displayed.

10. A computer-readable, non-transitory storage medium comprising a computer program configured to be executed by a computer, the computer program controlling the computer to execute functions of:
setting a plurality of areas on a desktop screen in accordance with a screen layout for the desktop screen comprising a plurality of regions;
allocating an application window on the desktop screen to one of the plurality of areas to display the application window in the one of the plurality of area; and
automatically saving setting information when the application window is allocated to the one of the plurality of areas and is displayed on the one of the plurality of areas,
wherein the setting information is indicative of (i) identification information of an application program corresponding to the application window, (ii) the screen layout, and (iii) the area in which the application window is displayed.
